(19) United States
(12) Patent Application Publication
(10) Pub. No.: US 2017/0199046 A1
(43) Pub. Date: Jul. 13, 2017

(54) METHOD OF CONTROL OF NAVIGATION AND ROUTE GUIDANCE SYSTEM OF VEHICLE

(71) Applicant: HYUNDAI MOTOR COMPANY, Seoul (KR)

(72) Inventors: Mihyun LEE, Incheon (KR); Kwanghun CHOI, Siheung-si (KR); Taehyun SUNG, Seoul (KR); Sungyong LEE, Yongin-si (KR)

(73) Assignee: HYUNDAI MOTOR COMPANY, Seoul (KR)

(21) Appl. No.: 15/355,228

(22) Filed: Nov. 18, 2016

(30) Foreign Application Priority Data
Jan. 12, 2016 (KR) 10-2016-0003697

(51) Int. Cl. G01C 21/34; G01C 21/36; H04W 4/02

(52) U.S. Cl. CPC G01C 21/3461; H04W 4/021; G01C 21/3415; G01C 21/3697

(57) ABSTRACT

Disclosed herein are control methods of a navigation and a route guidance system of a vehicle. In a control method of the navigation and the route guidance system, a geofence setting condition may be provided to allow setting of a geofence to be performed easily and efficiently, while combining a navigation function and a geofence function. Efficient route guidance may be performed by applying a geofence setting to a navigation route guide by combining a navigation function and a geofence function. A control method of a navigation function of a vehicle may include searching for a route to a destination and transmitting information of the searched route; receiving information related to a fence setting area set in the searched route; and, when the searched route is a route passing through the fence setting area, searching for and guiding by a new route that detours the fence setting area.

### CROSS-REFERENCE TO RELATED APPLICATION(S)

This application claims the benefit of Korean Patent Application No. 10-2016-0003697, filed on Jan. 12, 2016 in the Korean Intellectual Property Office, the entire contents of which is incorporated herein by reference.

### FIELD

The present disclosure relates to a vehicle, particularly a navigation function to guide by a route to a destination.

### BACKGROUND

The statements in this section merely provide background information related to the present disclosure and may not constitute prior art.

A navigation device may be configured to search a route to a designated destination in advance and display the route while displaying a position where a vehicle is currently placed in the route to the destination, and to guide the driver to the destination by the route. The guidance by the route to the destination may include an expressway preference guide, a highway preference guide, a shortest distance guide and a guide with a traffic condition, depending on a user' selection.

GeoFence may be a location-based Application Programming Interface (API). Etymologically, geofencing is a compound word of Geographic and Fencing. Geofencing may include API technology to provide a notification of the access status of the user within a fence. Geofencing may include an interface with GPS location tracking technology, and particularly, in a state in which a virtual fencing that is a geofence is designated through the GPS, when a user enters or exits the geofence area, the geofencing may provide a notification of the user's position. A “geofence” represents an area designated by a user that is a virtual boundary, and “geofencing” represents a function of monitoring if a user enters or exits a designated geofence (GPS fence).

Conventional navigation function and geofencing function may independently provide each respective service. Therefore, a navigation route guide that does not consider a geofence may be a cause of inconvenience to user.

In addition, since a variety of requirements of the user may not be applied when setting a geofence, greater convenience and accuracy in setting of the geofence may be required.

### SUMMARY

An aspect of the present disclosure provides a geofence setting condition to allow setting of a geofence to be performed easily and efficiently while combining a navigation function and a geofence function.

An aspect of the present disclosure provides a method for efficient route guidance by sufficiently applying a geofence setting to a navigation route guide by combining a navigation function and a geofence function.

Additional aspects of the present disclosure will be set forth in part in the description which follows and, in part, will be obvious from the description, or may be learned by practice of the present disclosure.

In accordance with an aspect of the present disclosure, a control method of a navigation function of a vehicle includes searching for a route to a destination and transmitting, to a terminal, information of the searched route; receiving, from the terminal, information related to a fence setting area set in the searched route; and, when the searched route is a route passing through the fence setting area, searching for and guiding by a new route that is detoured to the fence setting area.

Setting a fence in the terminal may include an operation in which a user of the terminal confirms the searched route and sets an area that is needed to be detoured and placed on the searched route.

The terminal may be a mobile device configured to be interconnected with a navigation device of the vehicle to communicate with the navigation device of the vehicle.

In accordance with an aspect of the present disclosure, a control method of a navigation function of a vehicle includes receiving, from a terminal, information related to a fence setting area set to a certain area; and, when the vehicle enters the fence setting area while the vehicle is driven in a state in which a route to a destination is not set in a navigation device, generating a warning to provide notification that a vehicle enters the fence setting area.

Setting a fence in the terminal may include an operation in which a user of the terminal sets, in a map, an area that is needed to be detoured.

The generation of warning may be performed in an inside of the vehicle.

The control method may further include an operation in which the navigation device of the vehicle notifies, to the terminal, that the vehicle enters the fence setting area.

The terminal may be a mobile device configured to be interconnected with the navigation device of the vehicle to communicate with the navigation device of the vehicle.

In accordance with an aspect of the present disclosure, a control method of a navigation function of a vehicle includes receiving, from a terminal, information related to a fence setting area set to a certain area; searching a route to a destination; when the route to the destination is a route entering the fence setting area, requesting, to the terminal, a release or change of the fence setting; and guiding by the route to the destination when receiving, from the terminal, a grant of the request of the release or change of the fence setting.

The control method may further include allowing a driver of the vehicle to select any one route from a plurality of routes when a plurality of routes different from each other is returned by searching for a route to the destination, wherein releasing or changing the fence setting may be requested to the terminal when the route selected by the driver is a route entering the fence setting area.

The control method may further include allowing a driver of the vehicle to select any one route from a plurality of routes when a plurality of routes different from each other is returned by searching for a route to the destination, wherein the route selected by the driver may be guided as a route to the destination without releasing or changing the fence setting when the route selected by the driver is not a route entering the fence setting area.

When the destination is placed inside of the fence setting area, the entering the fence setting area may include an operation in which the vehicle reaches the destination placed in the fence setting area.

When the destination is placed outside of the fence setting area, the entering the fence setting area may include an operation in which the vehicle reaches the destination by passing through the fence setting area.

The terminal may be a mobile device configured to be interconnected with the navigation device of the vehicle to communicate with the navigation device of the vehicle.

In accordance with an aspect of the present disclosure, a route guidance system of a vehicle includes a terminal configured to set a fence setting area to a certain area that is needed to be detoured; and a navigation device that is configured to search for a route to a destination and transmit, to the terminal, information related to the searched route, configured to receive, from the terminal, information related to a fence setting area in the searched route, and configured to, when the searched route is a route passing through the fence setting area, search for and guide by a new route that detours the fence setting are.

The terminal may be a mobile device configured to be interconnected with the navigation device of the vehicle to communicate with the navigation device of the vehicle.

In accordance with an aspect of the present disclosure, a route guidance system of a vehicle includes a terminal configured to set a fence setting area to a certain area that is needed to be detoured; and a navigation device that is configured to receive, from the terminal information related to the fence setting area, and configured to, when the vehicle enters the fence setting area while the vehicle is driven in a state in which a route to a destination is not set in a navigation device, generate a warning to provide notification that the vehicle enters the fence setting area.

The navigation device of the vehicle may be further configured to notify, to the terminal, that the vehicle enters the fence setting area.

The terminal may be a mobile device configured to be interconnected with the navigation device of the vehicle to communicate with the navigation device of the vehicle.

In accordance with another aspect of the present disclosure, a route guidance system of a vehicle includes a terminal configured to set a fence setting area to a certain area which is needed to be detoured; and a navigation device that is configured to receive, from the terminal, information related to the fence setting area, configured to, when the route to the destination is a route entering the fence setting area, request, to the terminal, a release or change of the fence setting, and configured to guide by the route to the destination when receiving, from the terminal, a grant of the request of the release or change of the fence setting.

The route guidance system may further be configured to allow a driver of the vehicle to select any one route from a plurality of routes when a plurality of routes different from each other is returned by searching for a route to the destination, wherein releasing or changing the fence setting may be requested to the terminal when the route selected by the driver is a route entering the fence setting area.

The route guidance system may further be configured to allow a driver of the vehicle to select any one route from a plurality of routes when a plurality of routes different from each other is returned by searching for a route to the destination, wherein the route selected by the driver may be guided as a route to the destination without releasing or changing the fence setting when the route selected by the driver is not a route entering the fence setting area.

The terminal may be a mobile device configured to be interconnected with the navigation device of the vehicle to communicate with the navigation device of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

These and/or other aspects of the disclosure will become apparent and more readily appreciated from the following description of forms, taken in conjunction with the accompanying drawings of which:

FIG. 1 is a view illustrating a navigation system of a vehicle configured to support a geofence function;

FIG. 2A is a view illustrating an interconnection between a telematics center and a vehicle through a modem;

FIG. 2B is a view illustrating an interconnection between a telematics center and a vehicle through a mobile device connection method;

FIG. 3 is a view illustrating an interior of a vehicle;

FIG. 4 is a view illustrating an Audio Video Navigation (AVN) device of a vehicle;

FIG. 5 is a view illustrating a navigation route guidance method of a vehicle in which a Web/Application (App)-based geofence setting is applied;

FIG. 6A is a view illustrating a screen of a geofence setting operated in a mobile device;

FIG. 6B is a view illustrating a screen of a geofence setting applied in a route guidance screen displayed on a display unit of a navigation device;

FIG. 7 is a view illustrating a fence setting method of a navigation device;

FIG. 8 is a view illustrating a fence setting method of a navigation device; and

FIG. 9 is a view illustrating a fence setting method of a navigation device.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure will be described more fully hereinafter with reference to the accompanying drawings, in which exemplary forms of the disclosure are shown.

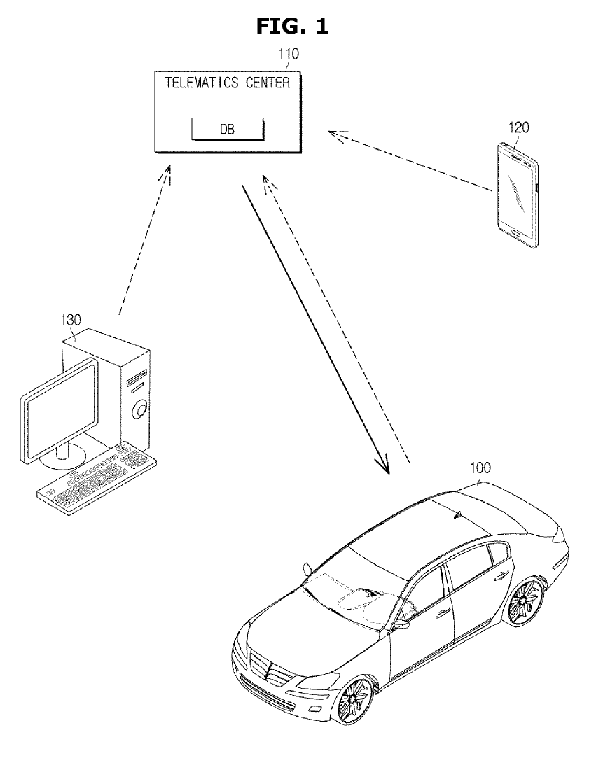

As illustrated in FIG. 1, a navigation system of a vehicle, which is configured support a geofence function, according to a form of the present disclosure may be performed based on an inter-communication between a vehicle 100 and a plurality of components including a telematics center 110, a mobile device 120, and a personal computer 130.

In the inside of the vehicle 100, an Audio Video Navigation (AVN) device and a telematics unit may be mounted. The AVN device may be a kind of a multi-media device that may perform an audio, a video, and a navigation function. The telematics unit may send/receive a telematics signal including voice/text/image data to/from the telematics center 110 by the communication through an antenna 152.

The telematics center 110 may provide telematics service to a subscriber vehicle. The telematics service may represent a remote information service for a vehicle to send/receive a variety of information and service in real-time via a mobile communication, internet, and navigation device based on a vehicle. By using the service, a user may check and respond to road traffic information including traffic condition, and may receive safety and security inspection of a vehicle, communication, navigation, and personalized information service. In addition, the telematics center 110 may provide a multi-media service, e.g. location information by combining with other services, traffic information, emergency rescue, and infotainment via a wireless communication net.

The mobile device 120 may include an internet-based multi-media device, e.g. a mobile phone, a tablet PC, and a web pad. The mobile device 120 may have a data communication function to use a Web/App service. The mobile device 120 may include a display unit to display a map and a menu. When the display unit supports a touch panel, a stylus input, a touch pen input, a touch input, and a key board input may be allowed. Via the mobile device 120, the use of a web/app service that supports setting a geofence may be allowed.

The personal computer 130 may be a desk top computer, a lap top computer, and a tablet PC. The use of the web service that supports setting a geofence may be allowed.

In the navigation system illustrated in FIG. 1, the following communication method may be used for a geofence setting. For example, in the mobile device 120, a geofence may be set to a desired target area through the web/app service. Selecting a geofence setting area may be performed by inputting an address through text/voice command or by selecting directly on a displayed map. Geofence setting information that is generated in the mobile device 120 by the user may be transmitted to the telematics center 110, passed through a series of authentication steps, transmitted to the vehicle 100, and then applied to a geofence setting in a navigation function of the vehicle 100. The authentication steps may include a step of identifying whether the geofence setting received via the telematics center 110 is set to a corresponding vehicle 100 or not. For this, when the geofence setting is performed, an identification number of the vehicle 100 may be inputted.

For another example, in the personal computer 130, setting geofence to a desired target area may be allowed through the web/app service. Selecting a geofence setting area may be performed by inputting an address through text/voice command or by selecting directly on a displayed map. Geofence setting information that is generated in the personal computer 130 by the user may be transmitted to the telematics center 110, passed through a series of authentication process, transmitted to the vehicle 100, and then applied to a geofence setting in a navigation function of the vehicle 100. The authentication process may include a process of identifying whether the geofence setting received via the telematics center 110 is set to a corresponding vehicle 100 or not. For this, when the geofence setting is performed, an identification number of the vehicle 100 may be inputted.

For another example, in the inside of the vehicle 100, setting geofence may be allowed through the navigation function. Selecting a geofence setting area may be performed by inputting an address through text/voice command or by selecting directly on a displayed map. Geofence setting information that is generated in the navigation function of the vehicle 100 by the user may be transmitted to the telematics center 110, passed through a series of authentication process, transmitted to the vehicle 100, and then applied to a geofence setting in the navigation function of the vehicle 100. The authentication process may include a process of identifying whether the geofence setting received via the telematics center 110 is set to a corresponding vehicle 100 or not. For this, when the geofence setting is performed, an identification number of the vehicle 100 may be inputted.

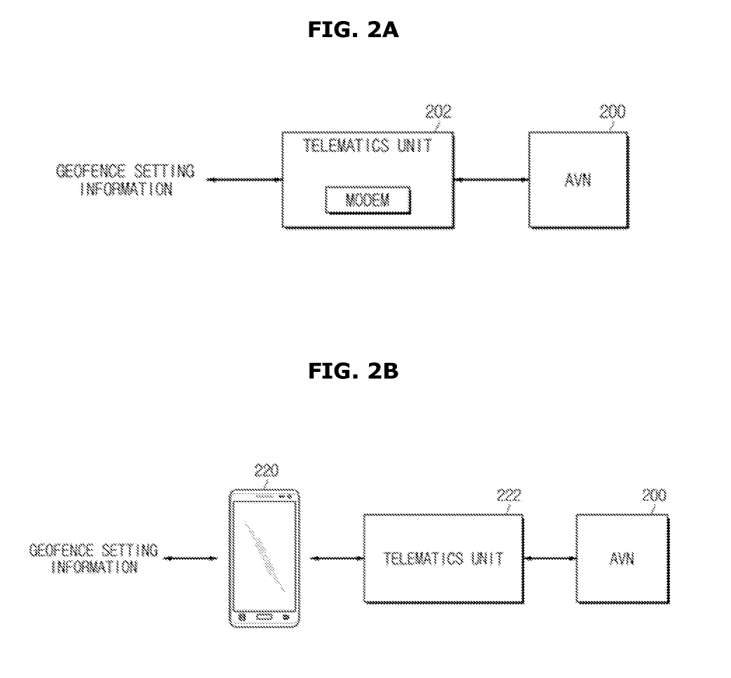

The interconnection through a modem illustrated in FIG. 2A may be allowed when a modem is provided in a telematics unit 202 mounted to the vehicle 100. The telematics unit 202 of the vehicle 100 may convert geofence setting information that is transmitted from the telematics center 110 to the vehicle 100 into information that is processable in the AVN device 200, through a modem, and then transmit the information to the AVN device 200. The AVN device 200 may display geofence setting content on a map of the navigation function based on the transmitted geofence setting information. In the interconnection through the modem as illustrated in FIG. 2A, when a geofence is set to a terminal/web/App and then stored, geofence setting information may be transmitted to the vehicle 100 via the telematics center 110 and the geofence setting may be performed in the vehicle 100.

The mobile device connection method of FIG. 2B may be a method in which a mobile device is used as the modem when a modem is not provided. As illustrated in FIG. 2B, the modem is not provided in a telematics unit 222. Therefore, by connecting a mobile device 220 to the telematics unit 222, the mobile device 220 may be allowed to play a role of the modem. The mobile device 220 of FIG. 2 may have a different function from that of the mobile device 120 of FIG. 1. The mobile device 120 of FIG. 1 may be a terminal used for a user placed in a remote location to set a geofence area, but the mobile device 220 of FIG. 2 may be used as a communication medium configured to receive geofence setting information of the AVN device 200 in the inside of the vehicle 100. The mobile device 220 may receive the geofence setting information transmitted from the telematics center 110 to the vehicle 100, and then transmit the geofence setting information to the mobile device 220. The mobile device 220 and the telematics unit 222 may be connected by using a wired communication method via a data cable. Alternatively, the mobile device 220 and the telematics unit 222 may be connected by using a short range wireless communication method, e.g. bluetooth, and NFC. The telematics unit 202 of the vehicle 100 may convert geofence setting information that is transmitted through the mobile device 220, into information that is processable in the AVN device 200, through a modem, and then transmit the information to the AVN device 200. The AVN device 200 may display geofence setting content on a map of the navigation function based on the transmitted geofence setting information.

For another example, an interconnection method in which the mobile device 220 is first connected to the AVN device 200 instead of the telematics unit 202, and thus the AVN device 200 and the telematics unit 202 are communicated, may be allowed. In the mobile device connection method of FIG. 2B, geofence setting information may be imported by selecting a function of “import” in the AVN device 200 of the vehicle 100 after geofence setting is performed in Web/App, so that geofence setting may be performed.

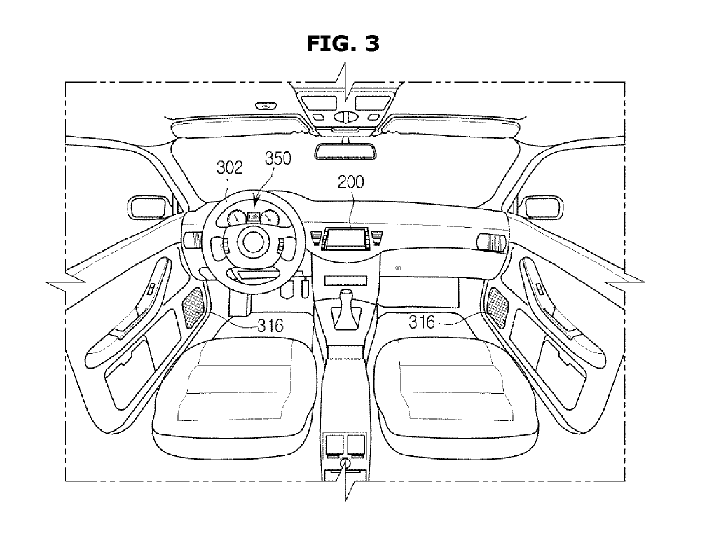

As illustrated in FIG. 3, an AVN device 200 and a steering wheel 302 may be mounted in a front side of a driver seat. The AVN device 200, which is formed such that an audio, a video, and a navigation device are integrally formed, may include a display unit. A speaker 316 may be mounted in a left door of the driver seat and a right seat of a passenger seat. Over the steering wheel 302, a cluster 350 may be provided. In the cluster 350, a variety of driving information of the vehicle 100 may be displayed.

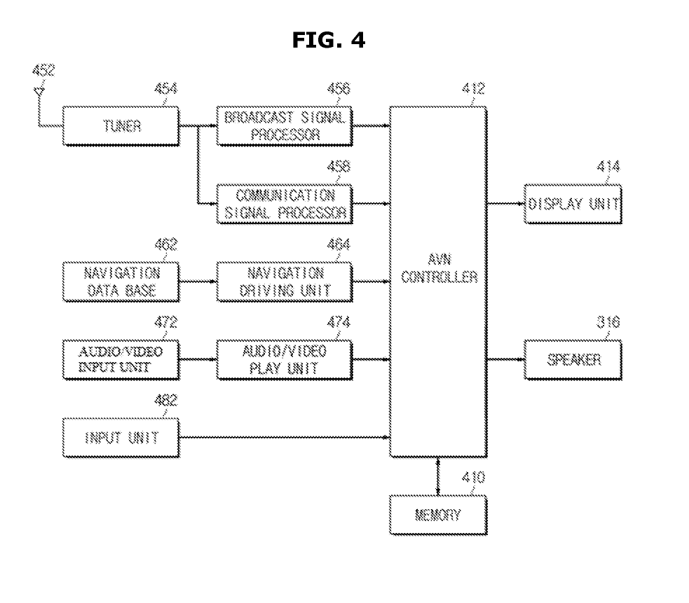

As illustrated in FIG. 4, a configuration of the AVN device 200 may be divided into a component for a general input function, a component for a broadcast/communication function, a component for a navigation function, a component for an audio/video function, and a component to be commonly used for a plurality of functions.

The component for a broadcast/l communication function may include an antenna 452, a tuner 454, a broadcast signal processor 456, and a communication signal processor 458. The component for a navigation function may include a navigation data base 462 and a navigation driving unit 464. The component for an audio/video function may include an audio/video input unit 472 and an audio/video play unit 474. The component for a general input function may include an input unit 482. The component to be commonly used for a plurality of functions may include a memory 410, a controller 412, a display unit 414 and a speaker 316. A division of function is not limited thereto, and thus a component for any one function may be also used for other function.

The antenna 452 may be configured to send/receive radio waves to/from the air for the reception of the broadcast signal or the transmission and reception of the communication signal. The antenna 452 may be connected to the tuner 454 for communication with each other. Therefore, radio waves received via the antenna 452 may be transmitted to the tuner 454. A plurality of antenna 452 may be provided for the different types of broadcast/communication signal.

The tuner 454 may receive radio waves received via the antenna 452 and then convert the radio waves into an intermediate frequency signal. In addition, the tuner 454 may convert a data signal that is intended to be transmitted into the type of signal that is transmittable to the air, and then transmit the signal to the air via the antenna 452. That is the tuner 454 may perform an operation, e.g. extracting a signal in a certain band or combining a data signal with a carrier wave. The tuner 454 may perform reception of broadcast signal and transmission and reception of communication signal. The broadcast signal may include a radio broadcast signal and a Digital Multimedia Broadcasting (DMB) broadcast signal. The communication signal may include a satellite communication signal with a Global Positioning System (GPS) satellite (hereinafter referred to as GPS satellite). In addition, the communication signal may include a communication signal for telematics. Which signal is received and processed in the tuner 454 may be determined by a control signal transmitted from the controller 412 to the tuner 454. For example, when the controller 412 generates a control signal and transmits the control signal to the tuner 454 so that the tuner 454 receives a radio broadcast signal in a certain channel, the tuner 454 may receive a radio broadcast signal in a corresponding channel in response to the control signal transmitted from the controller 412. When the controller 412 transmits a control signal and transmission data to the tuner 454 for the transmission of the telematics signal, the tuner 454 may convert the transmission data into the type of signal transmittable to the air in response to the control signal transmitted from the controller 412, and then transmit the signal to the air via the antenna 452. In addition, the tuner 454 may obtain information of a broadcast channel included in a broadcast signal. The broadcast signal inputted in the tuner 454 may include the name of the broadcast channel, service Identification (ID), and broadcast data. The tuner 454 may extract the name of the broadcast channel, the service Identification (ID), and the broadcast data included in the broadcast signal, and then transmit the name of the broadcast channel, the service Identification (ID), and the broadcast data included in the broadcast signal to the broadcast signal processor 456 and the controller 412.

The broadcast signal processor 456 may perform a series of signal processing steps by distinguishing the broadcast signal passed through the tuner 454 into a video broadcast signal and an audio broadcast signal. The series of signal processing steps performed in the broadcast signal processor 456 may include analog-digital conversion, digital-analog conversion, and converting a video data into the type of signal capable of driving the display unit 414.

The communication signal processor 458 may perform a step of processing a communication signal with GPS satellite and a step of processing a telematics communication signal. That is, the communication signal processor 458 may convert a received communication signal into the type of data to be transmitted to the controller 412 or may receive data, which is intended to be transmitted via the tuner 454 and the antenna 452, and then convert the data into the type of signal that is allowed to be communicated.

The navigation data base 462 may include data to implement a navigation function. The navigation data base 462 may be a memory card or Digital Versatile Disc (DVD). In addition, navigation data that is provided from a mobile terminal connected through a link in a wired/wireless method, e.g. CarPlay or Android Auto, may be used as a navigation data base.

The navigation driving unit 464 may form a navigation screen on the display unit 414 by using data provided from the navigation data base 462. For this, the navigation driving unit 464 may receive navigation setting information set by a driver, e.g. a destination, a transit point, and a route type, from the controller 412. In addition, in order to implement the navigation function, the navigation driving unit 464 may receive current location information of a vehicle obtained through a communication with GPS satellite.

The audio/video input unit 472 may be an Optical Disc Drive. In addition, the audio/video input unit 472 may be a USB input/output device or an Auxiliary (AUX) input/output terminal. The audio/video input unit 472 may be a Bluetooth device for a wireless connection with a mobile terminal. The mobile terminal connected to the audio/video input unit 472 via bluetooth may be a mobile phone or a portable digital music player.

The audio/video play unit 474 may allow audio/video data inputted via the audio/video input unit 472 to be outputted via the speaker 316 and the display unit 414. For example, when the audio/video input unit 472 is an optical disc drive, the optical disc drive may read out audio/video data that is recorded in an optical disc (e.g. CD/DVD/BD) and then output the audio/video data, and the audio/video play unit 474 may convert the audio/video data outputted by the audio/video input unit 472 into the type of signal capable of driving the speaker 316 and the display unit 414, and then transmit the signal to the speaker 316 and the display unit 414 so that an audio/video may be played. Audio/video data, which is provided from another medium other than the optical disc, may be converted into the type of signal capable of driving the speaker 316 and the display unit 414.

The input unit 482 may be at least one button provided in the AVN device 200 or a touch screen implemented in the display unit 414. The driver may select one function of multiple functions of the AVN device 200 through an operation of the input unit 482, and may apply a variety of settings so that a desired work is performed through the selected function. A voice recognition button 104 of the above-mentioned steering wheel 302 may be included in the at least one button forming the input unit 482.

The controller 412 may perform a control that is needed for an overall operation of the AVN device 200. For example, the controller 412 may perform a process of broadcast/communication signal. When audio/video data that is generated after processing of a broadcast/communication signal is needed to be outputted via the speaker 316 or the display unit 414, the controller 412 may perform a control to allow the audio/video data to be transmitted to the speaker 316 and the display unit 414 so that the needed audio/video data is outputted. In addition, when the driver selects a navigation function, the controller 412 may allow the navigation function to be implemented by controlling the navigation data base 462, the navigation driving unit 464, the display unit 414, and the speaker 316. The controller 412 may perform a control to allow audio/video data inputted via the audio/video input unit 472 to be played via the audio/video play unit 474 and then transmitted to the speaker 316 and the display unit 414 so that a needed audio/video data is outputted.

In the memory 410, a variety of applications that are performed to operate each of broadcast/communication function, and audio/video function of the AVN device 200, and screen display data, voice data, and sound effect data, all of which are needed for an operation of the applications, may be stored.

The display unit 414 may output a video associated with performing multiple functions, e.g. the broadcast/communication function, the navigation function, and the audio/video function of the AVN device 200. For example, a guide screen or message of each function, and video data, may be outputted via the display unit 414.

The speaker 316 may output an audio associated with performing multiple functions, e.g. the broadcast/communication function, the navigation function, and the audio/video function of the AVN device 200. For example, a guide comment and sound effect of each function, and audio data, may be outputted via the speaker 316.

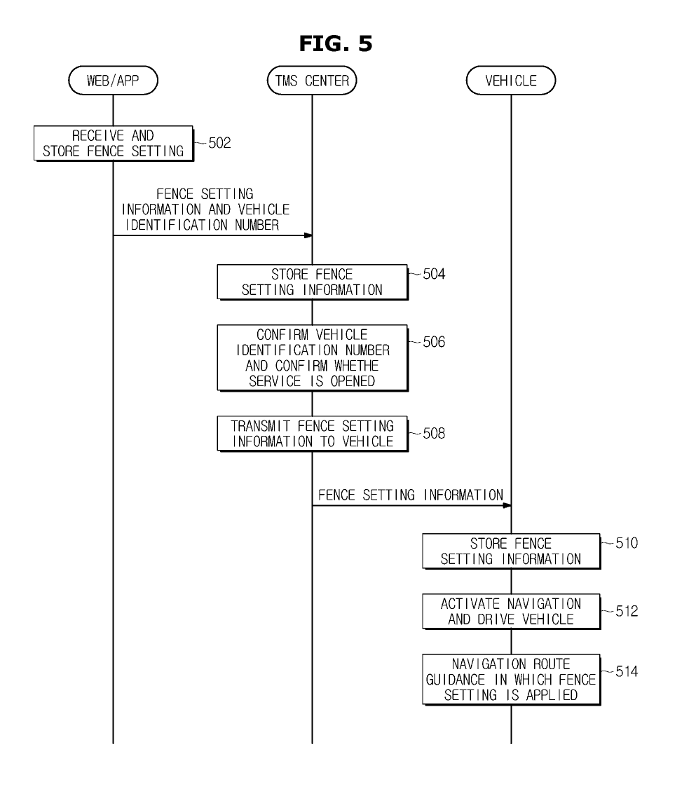

As illustrated in FIG. 5, in the navigation route guidance method of a vehicle, a user may set a Web/App-based geofence via the mobile device 120 or the personal computer 130, the telematics center 110 may receive and transmit geofence setting information to the telematics unit of the vehicle 100, and the AVN device 200 of the vehicle 100 may perform a navigation route guidance in which the geofence setting is applied.

As illustrated in FIG. 5, at first, the user may set a Web/App-based geofence via the mobile device 120 or the personal computer 130. That is, when the user accesses a Web/App-based geofence service and then sets a geofence area to target area, the corresponding geofence setting content may be transmitted to a geofence service provider and then stored. The Web/App-based geofence setting content may be transmitted to the Web/App-based service provider and stored in the Web/App-based service provider (502). When using the mobile device 120, a user may access the Web by using the mobile device 120 and set a geofence having intended content by using a Web-based geofence setting service. In addition, a geofence setting having intended content may be performed by using an App-based geofence setting service by operating an application installed in the mobile device 120. In addition, in a case of using the personal computer 130, a user may access the Web by using the personal computer 130 and set a geofence having intended content by using a Web-based geofence setting service. A detail description thereof will be described later. When the Web/App-based geofence setting is completed, the generated geofence setting information may be transmitted to the telematics center 110 together with Vehicle Identification Number (VIN).

In the telematics center 110 that receives the fence setting information and the vehicle identification number, the received geofence setting information may be stored (504). In addition, vehicle identification information of the corresponding vehicle identification number may be confirmed with reference to the received vehicle identification number, and whether telematics service of the corresponding vehicle is opened may be confirmed (506). When there is no problem in the vehicle identification information of the corresponding vehicle identification number and the telematics service of the corresponding vehicle is opened, the telematics center 110 may transmit geofence setting information to the corresponding vehicle 100 (508).

The vehicle 100 may store geofence setting information received via the telematics unit 202 in the memory 410 of the AVN device 200. When the Web/App-based geofence setting is completed, a user (driver) may drive a vehicle after starting an ignition and activating the navigation function (512). The activation of the navigation function may include allowing a route guidance to be performed by setting a destination and selecting a route to the destination. While performing route guidance to the destination set by the user, the AVN device 200 of the vehicle 100 may perform a route guidance by applying the geofence setting of the user (514). A detail description of the route guidance in which the geofence setting is applied will be described later.

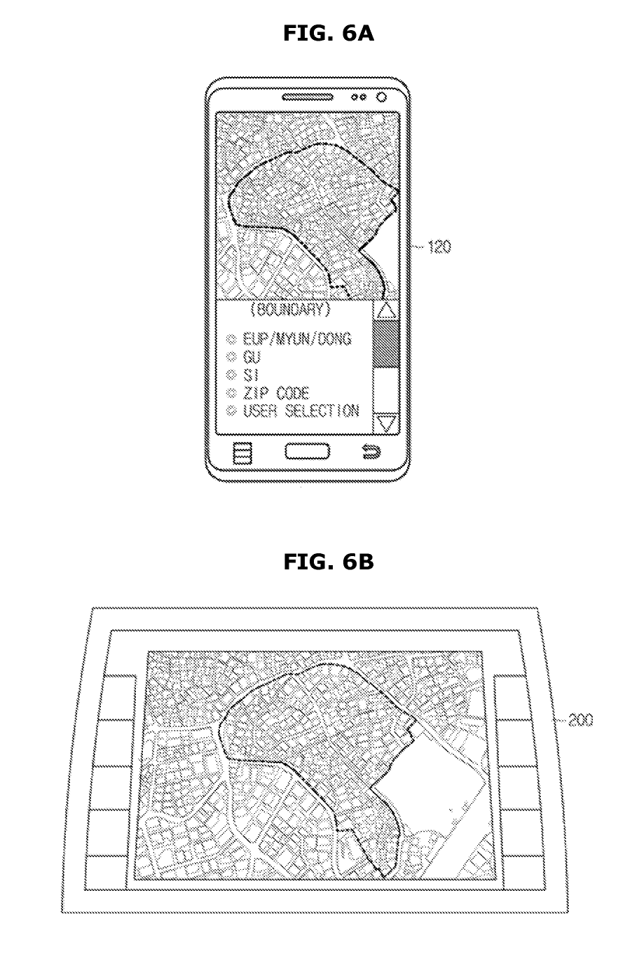

FIG. 6A illustrates a geofence setting screen operated in the mobile device 120. Since the mobile device 120 has a display unit having a relative small size, a map and a menu may be displayed in an upper portion and a lower portion, respectively, and when a content intended to be displayed is not displayed on a single screen, a scroll bar may be provided. FIG. 6B illustrates a route guidance screen displayed on the display unit 414 of the AVN device 200, and in which a geofence setting is applied. When the geofence setting is performed in the mobile device 120 and the geofence setting content is transmitted to the AVN device 200, a map in which the geofence setting is applied may be displayed on the display unit 414 of the AVN device 200.

Since a screen of a monitor of the personal computer 130 and a screen of the display unit 414 of the AVN device 200 have a relatively big size, a graphic user interface may be composed in a horizontal arrangement method, and a needed menu and map may be displayed so that a user may perform a needed selection.

As illustrated in FIG. 6A, in one side, e.g. the left side, of the graphic user interface, a menu list to select a search condition item for a geofence setting may be displayed, and in the rest of the screen, a map may be displayed. The user may input a specific search condition of the corresponding item by selecting a desired item in the menu list.

In a fence setting method of a navigation function, when a user of the mobile device 120 sets a fence on the mobile device 120 to be considered in association with a route search result to a destination that is set via the AVN device 200 by a driver of the vehicle 100, the AVN device 200 may search for and guide by a route detouring the fence.

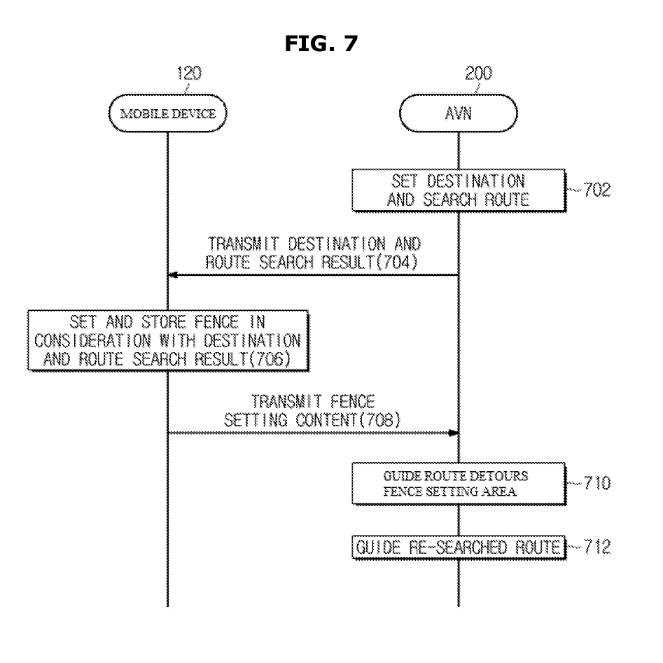

As illustrated in FIG. 7, when the driver of the vehicle 100 sets a desired destination in the AVN device 200 and searches for a route to the destination (702), the AVN device 200 may transmit the destination and a route search result to the mobile device 120 (704). Therefore, the user of the mobile device 120 may confirm the destination that is set by the driver of the vehicle 100, and the route search result, via the mobile device 120.

The user of the mobile device 120 who confirms the destination that is set by the driver of the vehicle 100 and the route search result via the mobile device 120 may set and store a fence to be considered in association with the destination and the route search result set in the AVN device 200 (706). That is, when the vehicle 100 is needed to detour since there is a certain area, e.g. a dangerous area, a plague infected area, a crime prone area, a military area, and a bad weather area, on the route to the destination set in the AVN device 200, the user of the mobile device 120 may set a fence to the corresponding area so that the vehicle 100 detours a fence setting area. The reason why the user of the mobile device 120 sets a fence to a certain area in the route searched by the AVN device 200 is that the vehicle 100 detours the certain area so that the vehicle 100 avoids the certain area. The fence setting content (setting area information) set by the user of the mobile device 120 may be transmitted from the mobile device 120 to the AVN device 200 of the vehicle 100 (708).

When receiving the fence setting content set by the user of the mobile device 120, the AVN device 200 of the vehicle 100 may re-search for a new route, which detours the fence setting area set by the user of the mobile device 120, on a previous search route (710). Since the fence setting area set by the user of the mobile device 120 is not applied to the previous search route, the new route, which detours the fence setting area, may be re-searched. When re-searching the new route, which detours the fence setting area, is completed, the AVN device 200 may guide by a re-searched new route to the driver (712).

When a fence is set to the overall area of 00 dong (i.e. a particular neighborhood) 00 gu (i.e. a particular district containing the neighborhood) of Seoul, the AVN device 200 may recognize that a fence is set to the overall area of 00 dong and confirm the latitude and longitude coordinates of the overall area of 00 dong. Therefore, in a state in which the navigation function of the AVN device 200 re-searches a new route to the destination, and the coordinates of searched route include the latitude and longitude coordinates of 00 dong, to which the fence is set, the corresponding route may be not accepted and another route may be additionally re-searched. By using the above-mentioned method, a new route excluding the latitude and longitude coordinates of 00 dong, to which the fence is set, may be searched and then provided to the driver.

As mentioned above, when the vehicle is driven by searching a route in which the fence setting is not applied through the AVN device 200 of the vehicle 100, the user of the mobile device 120 placed in a remote location may confirm a route search result of the AVN device 200 and allow the vehicle 100 to detour by setting a fence as needed. When the driver of the vehicle 100 is in a condition making the driver incapable of setting a fence directly, the above-mentioned method may be useful. When the driver of the vehicle 100 does not recognize that there is a certain area that is needed to be detoured in a search route, the user of the mobile device 120 may set a fence to the certain area so that the safety of the driver of the vehicle 100 may be secured.

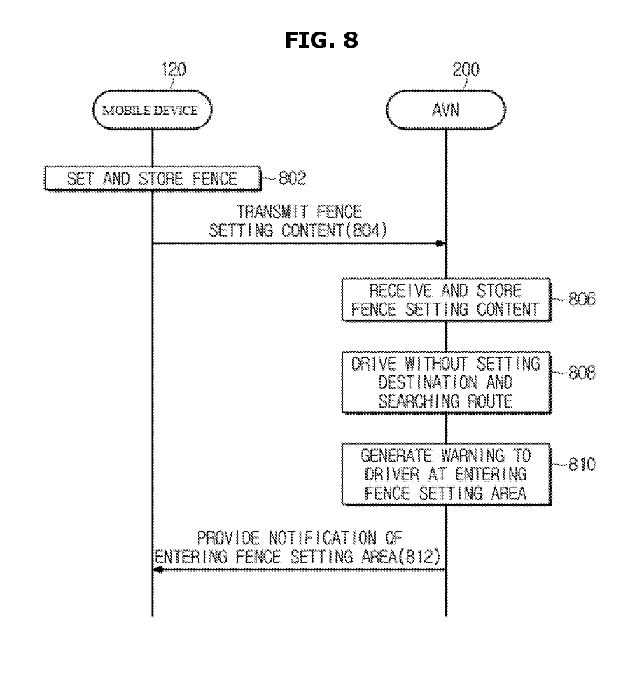

In the fence setting method of the navigation function illustrated in FIG. 8, when the user of the mobile device 120 sets and stores a fence via the mobile device 120, the fence setting content of the mobile device 120 may be transmitted to the AVN device 200 and stored in the AVN device 200. Accordingly, although the driver of the vehicle 100 is not using a route search function of the AVN device 200, when the vehicle 100 enters a fence area set by the user of the mobile device 120, the vehicle 100 may alert the driver by generating a warning.

As illustrated in FIG. 8, the user of the mobile device 120 may set a fence to a certain area and store the fence on the mobile device 120 (802). That is, when the vehicle 100 is needed to detour since there is a certain area, e.g. a dangerous area, a plague infected area, a crime prone area, a military area, and a bad weather area, the user of the mobile device 120 may set a fence to the corresponding area so that the vehicle 100 detours a fence setting area.

When setting a fence to the certain area is completed on the mobile device 120, the fence setting content may be transmitted to the AVN device 200 of the vehicle 100 (804). The AVN device 200 of the vehicle 100 may receive the fence setting content from the mobile device 120 and store the fence setting content (806).

In a state in which the fence setting content is stored in the AVN device 200 of the vehicle 100, the driver of the vehicle 100 may drive the vehicle 100 without setting a destination and searching a route of the AVN device 200 (808). For example, when a driver well knows a route to a desired destination, the driver may not use the route guidance function of the navigation function. In addition, when a driver drives the vehicle without setting a certain destination, the driver may not use the route guidance function of the navigation function.

As mentioned above, when the driver of the vehicle 100 drives the vehicle 100 while not using the route guidance function of the AVN device 200, when the vehicle 100 is expected to enter or already entered a fence setting area set by the user of the mobile device 120, the vehicle 100 may alert the driver of entry into the fence setting area by generating a warning (810). The driver of the vehicle 100 may not recognize that there is a certain area needed to be detoured since the driver has not set a fence and also is not using the route guidance function of the navigation function. In this case, the user of the mobile device 120 placed in a remote location may set a fence to a certain area and transmit the fence setting content to the AVN device 200, and thus, although the driver of the vehicle 100 is not using the route guidance function, the vehicle may generate a warning to alert the driver so that the vehicle 100 detours the fence setting area.

When the vehicle 100 is expected to enter or already entered a fence setting area, providing a notification that the vehicle 100 enters the fence setting area from the AVN device 200 to the mobile device 120 while generating a warning via the AVN device 200 of the vehicle 100, may allow the user of the mobile device 120 to recognize that the vehicle 100 enters the fence setting area (812). When the driver of the vehicle 100 keeps driving and ignoring the warning of entering the fence setting area or when the driver is incapable of escaping from the fence setting area due to an inevitable reason, the notification of the entering fence setting area from the AVN device 200 to the mobile device 120, may allow the user of the mobile device 120 to confirm a current situation of the driver and to take measures to help the driver of the vehicle 100 so that the driver of the vehicle 100 escapes from the fence setting area.

When a fence is set to an overall area of 00 dong 00 gu Seoul, the AVN device 200 may recognize that a fence is set to the overall area of 00 dong 00 gu Seoul and confirm the latitude and longitude coordinates of the overall area of 00 dong. Therefore, when the vehicle 100 enters 00 dong, to which a fence is set, while the vehicle 100 is driven in a state in which the navigation function of the AVN 200 is activated (but a route is not set), the AVN device 200 may recognize that the vehicle 100 enters 00 dong, to which a fence is set, by comparing coordinates of a current location of the vehicle 100 with the latitude and longitude coordinates of 00 dong, to which a fence is set, and the AVN device 200 may inform the driver of entry into the fence setting area.

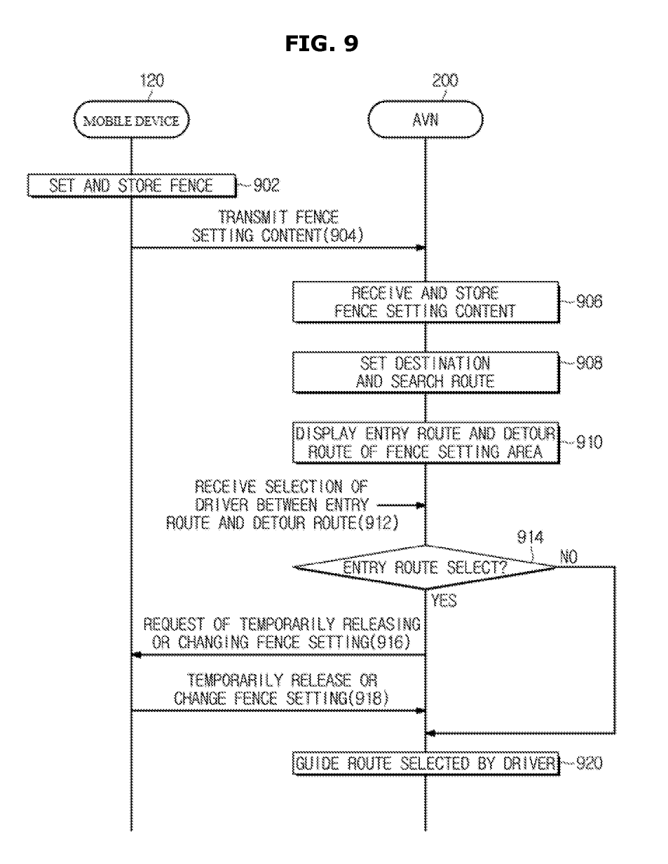

In a fence setting method of the navigation function as illustrated in FIG. 9, in a state in which the user of the mobile device 120 sets a fence via the mobile device 120, when the driver of the vehicle 100 wants to use a route to enter the fence setting area with reference to a route guidance by the AVN device 200, the driver of the vehicle 100 may send a request of a temporary release of a fence setting or a change of a fence setting to the user of the mobile device 120, so that the driver of the vehicle 100 may use the route to enter the fence setting area.

As illustrated in FIG. 9, the user of the mobile device 120 may set a fence to a certain area and store the fence on the mobile device 120 (902). That is, when the vehicle 100 is needed to detour since there is a certain area, e.g. a dangerous area, a plague infected area, a crime prone area, a military area, and a bad weather area, the user of the mobile device 120 may set a fence to the corresponding area so that the vehicle 100 detours a fence setting area when the vehicle 100 passes the corresponding area.

When setting a fence setting to the certain area is completed on the mobile device 120, the fence setting content may be transmitted to the AVN device 200 of the vehicle 100 (904). The AVN device 200 of the vehicle 100 may receive the fence setting content from the mobile device 120 and store the fence setting content (906).

In a state in which the fence setting content is stored in the AVN device 200 of the vehicle 100, the driver of the vehicle 100 may set a destination and search a route to the destination in the AVN device 200 (908). When searching the route to the destination in the navigation function of the AVN device 200, the AVN device 200 may search a variety of routes and then provide the variety of routes to the driver. For example, the variety of routes, e.g. an expressway preference route, a highway preference route, a shortest distance route, and a shortest time route, may be displayed and provided to the driver to allow the driver to select any one route of the variety of routes.

When the variety of routes to reach the destination is searched, from the searched routes, an enter route and a detour route of the fence setting area may be displayed via the display unit 414 (910). The enter route may represent a search route for a case in which the vehicle 100 is needed to enter the inside of the fence setting area since a destination is placed in the fence setting area, or a case in which the vehicle 100 has to pass through the fence setting area to reach the destination. The detour route may represent a search route for a case in which the vehicle 100 detours the fence setting area since the fence setting area is placed between a current location of the vehicle 100 and the destination.

When the enter route and the detour route are displayed on the display unit 414, the driver may select any one desired route, and the AVN device 200 of the vehicle 100 may receive the selection of the driver of any one of the enter route and the detour route (912). The route selection of the driver may be performed by operating a touch screen on the display unit 414 or by operating an additional direction key or joy stick. In addition, by using a voice command function, selecting a desired route may be performed by vocalizing directly by the driver.

When the driver selects the enter route (e.g. “Yes” choice at step 914), the AVN device 200 of the vehicle 100 may send a request of a temporary release of the fence setting or a change of the fence setting to the mobile device 120 (916). The user of the mobile device 120 may temporarily release the fence setting or change the fence setting via the mobile device 120 in response to the request for the temporary release of the fence setting or the change of the fence setting (918). The temporary release of the fence setting or the change the fence setting performed by the user of the mobile device 120 may be transmitted to the AVN device 200 of the vehicle 100.

When receiving the temporary release of the fence setting or the change of the fence setting performed by the user from the mobile device 120, the AVN device 200 of the vehicle 100 may guide the driver to the destination by using the route selected by the driver (920). In this case, the route may represent an “enter route”. Since the fence setting is temporarily released or the fence setting is changed by the user, the AVN device 200 may be capable of fully guiding by the route selected by the driver without the effect of the fence setting.

When the driver selects the detour route in the step of 914 (e.g. “No” choice at step 914), the AVN device 200 of the vehicle 100 may guide the driver by the detour route selected by the driver taking into consideration the fence setting in a step 920 of guiding by a route selected by the driver.

As is apparent from the above description, according to the proposed method of control navigation and route guidance system of vehicle, a geofence setting condition may be provided to easily and efficiently perform a geofence setting while a navigation function and a geofence function are combined.

By combining a navigation function and a geofence function, a geofence setting may be fully applied to a navigation route guidance system so that a route guidance may be efficiently performed.

Although a few forms of the present disclosure have been shown and described, it would be appreciated by those skilled in the art that changes may be made in these forms without departing from the principles and spirit of the disclosure, the scope of which is defined in the claims and their equivalents.

### DESCRIPTION SYMBOLS

100: vehicle
110: telematics center
120, 220: mobile device
130: personal computer
200: AVN (Audio Video Navigation) device

What is claimed is:

1. A control method of a navigation function of a vehicle comprising:
searching for a route to a destination and transmitting, to a terminal, information of the searched route;
receiving, from the terminal, information related to a first fence setting area that is set in the searched route; and
when the searched route is a route passing through the first fence setting area, searching for and guiding by a new route that detours the first fence setting area.

2. The control method of claim 1 wherein:
setting a fence in the terminal comprises an operation in which a user of the terminal confirms the searched route and sets an area that is needed to be detoured and placed on the searched route.

3. The control method of claim 1 wherein:
the terminal is a mobile device configured to be interconnected with a navigation device of the vehicle to communicate with the navigation device of the vehicle.

4. The control method of claim 1, further comprising:
receiving, from the terminal, information related to a second fence setting area set to a certain area;
when the route to the destination is a route entering the second fence setting area, requesting, to the terminal, a release or change of the fence setting of the second fencing setting area; and
guiding by the route to the destination when receiving, from the terminal, a grant of the request of the release or change of the fence setting of the second fencing setting area.

5. The control method of claim 4 further comprising:
allowing a driver of the vehicle to select any one route from a plurality of routes when a plurality of routes different from each other is returned by searching for a route to the destination,
wherein releasing or changing the fence setting is requested to the terminal when the route selected by the driver is a route entering the second fence setting area.

6. The control method of claim 4 further comprising:
allowing a driver of the vehicle to select any one route from a plurality of routes when a plurality of routes different from each other is returned by searching for a route to the destination,
wherein the route selected by the driver is guided as a route to the destination without releasing or changing the fence setting when the route selected by the driver is not a route entering the second fence setting area.

7. The control method of claim 4 wherein:
when the destination is placed inside of the second fence setting area, the entering the second fence setting area comprises an operation in which the vehicle reaches the destination placed in the second fence setting area.

8. The control method of claim 4 wherein:
when the destination is placed outside of the second fence setting area, the entering the second fence setting area comprises an operation in which the vehicle reaches the destination by passing through the second fence setting area.

9. A control method of a navigation function of a vehicle comprising:
receiving, from a terminal, information related to a fence setting area set to a certain area; and
when the vehicle enters the fence setting area while the vehicle is driven in a state in which a route to a destination is not set in a navigation device, generating a warning to provide notification that the vehicle enters the fence setting area.

10. The control method of claim 9 wherein:
setting a fence in the terminal comprises an operation in which a user of the terminal sets, in a map, an area that is needed to be detoured.

11. The control method of claim 9 wherein:
the generation of warning is performed in an inside of the vehicle.

12. The control method of claim 11 further comprising:
an operation in which the navigation device of the vehicle notifies, to the terminal, that the vehicle enters the fence setting area.

13. The control method of claim 9 wherein:
the terminal is a mobile device configured to be interconnected with the navigation device of the vehicle to communicate with the navigation device of the vehicle.

14. A route guidance system of a vehicle comprising:
a terminal configured to set a fence setting area to a certain area that is needed to be detoured; and
a navigation device configured to:
search for a route to a destination and transmit, to the terminal, information related to the searched route,
receive, from the terminal, information related to a fence setting area in the searched route, and
when the searched route is a route passing through the fence setting area, search for and guide by a new route that detours the fence setting area.

15. The route guidance system of claim 14 wherein:
the terminal is a mobile device configured to be interconnected with the navigation device of the vehicle to communicate with the navigation device of the vehicle.

16. A route guidance system of a vehicle comprising:
a terminal configured to set a fence setting area to a certain area that is needed to be detoured; and
a navigation device configured to:
receive, from the terminal, information related to the fence setting area, and
when the vehicle enters the fence setting area while the vehicle is driven in a state in which a route to a destination is not set in the navigation device, generate a warning to provide notification that the vehicle enters the fence setting area.

17. The route guidance system of claim 16, wherein:
the navigation device of the vehicle is further configured to notify, to the terminal, that the vehicle enters the fence setting area.

18. The route guidance system of claim 16 wherein:
the terminal is a mobile device configured to be interconnected with the navigation device of the vehicle to communicate with the navigation device of the vehicle.
